(19) United States
(12) Patent Application Publication
(10) Pub. No.: US 2019/0052632 A1
(43) Pub. Date: Feb. 14, 2019

(54) AUTHENTICATION SYSTEM, METHOD AND NON-TRANSITORY COMPUTER-READABLE STORAGE MEDIUM

(71) Applicant: FUJITSU LIMITED, Kawasaki-shi (JP)

(72) Inventor: Junji TAKAGI, Kawasaki (JP)

(73) Assignee: FUJITSU LIMITED, Kawasaki-shi (JP)

(21) Appl. No.: 16/044,645

(22) Filed: Jul. 25, 2018

(30) Foreign Application Priority Data
Aug. 10, 2017 (JP) 2017-155717

(51) Int. Cl. H04L 29/06; H04L 9/32; H04L 9/08

(52) U.S. Cl. CPC H04L 63/0861; H04L 63/12; H04L 9/321; G06F 7/58; H04L 9/3247; H04L 9/3271; H04L 9/0825

(57) ABSTRACT

An authentication system configured to perform an authentication process by using a template generated from biometric data, the authentication system includes a first server, and a second server, wherein the first server includes a first memory, and a first processor configured to generate, based on first identification information of a first service provided by the second server, a first random number used for generating the template from the biometric data, generate a signature random number by electrical signing of the first random number by using a secret key, and transmit the signature random number to the second server, and the second server includes, a second memory, and a second processor configured to verify the electrical signing by using a public key that corresponds to the secret key, and store, into the second memory, the signature random number when verification of the electrical signing succeeds.

### CROSS-REFERENCE TO RELATED APPLICATION

This application is based upon and claims the benefit of priority of the prior Japanese Patent Application No. 2017-155717, filed on Aug. 10, 2017, the entire contents of which are incorporated herein by reference.

### FIELD

The embodiments discussed herein are related to an authentication system, a method and a non-transitory computer-readable storage medium.

### BACKGROUND

In recent years, a technique has been known which confirms identity by using biometric authentication in a case where a cloud service is used from a mobile terminal such as a smartphone or a tablet. In such a technique, there has been a biometric template protection technique in which biometric data are in advance registered while being converted into biometric protection data (template), biometric data acquired in authentication are converted and compared with the registered template, and identity is thereby confirmed. In the biometric template protection technique, the template is generated by using a conversion parameter.

One example of the template protection technique is a technique in which a client side manages the conversion parameter. In such a technique, a client terminal acquires biometric information of a user in registration, converts the acquired biometric information by a conversion parameter which is a conversion parameter saved in an IC card or the like and is issued for the user, and thereby creates the template. Further, the client terminal registers the created template together with verification information for the conversion parameter in an authentication server. In authentication, the authentication server verifies that the client terminal knows the conversion parameter by using the verification information, compares comparison information, which results from conversion of the biometric information of the user by the conversion parameter, with the template, and thereby performs identity confirmation.

Further, another example of the template protection technique is a technique in which a server side manages the conversion parameter. In such a technique, a parameter management server generates the conversion parameter by using a user ID, a master key, and a temporary parameter, which are sent from the client terminal. The client terminal extracts a characteristic amount from the biometric information acquired by a biometric information sensor, converts the characteristic amount by using the conversion parameter generated by the parameter management server, and thereby generates a converted characteristic amount. The authentication server performs the identity confirmation by comparing the converted characteristic amount, which is sent from the client terminal, with the template, which is in advance complemented. Related art documents are Japanese Laid-open Patent Publication No. 2008-92413, Japanese Laid-open Patent Publication No. 2013-178801, and Japanese Laid-open Patent Publication No. 2009-9293.

### SUMMARY

According to an aspect of the invention, an authentication system configured to perform an authentication process by using a template generated from biometric data, the authentication system includes a first server, and a second server, wherein the first server includes a first memory, and a first processor coupled to the first memory and configured to generate, based on first identification information of a first service provided by the second server, a first random number used for generating the template from the biometric data, generate a signature random number by electrical signing of the first random number by using a secret key, and transmit the signature random number to the second server, and the second server includes, a second memory, and a second processor coupled to the second memory and configured to verify the electrical signing by using a public key that corresponds to the secret key, and store, into the second memory, the signature random number when verification of the electrical signing succeeds.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a function block diagram that illustrates a configuration of an authentication system according to a first embodiment;

FIG. 2 is a diagram for explaining one example of salt generation according to the first embodiment;

FIG. 3 is a diagram that illustrates one example of metadata;

FIG. 4 is a diagram that illustrates one example of a salt signature verification result management table according to the first embodiment;

FIG. 5A is a diagram that illustrates one example of a salt management table according to the first embodiment;

FIG. 5B is a diagram that illustrates another example of the salt management table according to the first embodiment;

FIG. 6 is a diagram that illustrates one example of a flowchart of a salt generation process according to the first embodiment;

FIG. 7 is a diagram that illustrates one example of a flowchart of a salt management process according to the first embodiment;

FIG. 8 is a diagram that illustrates one example of a flowchart of a biometric protection data generation process according to the first embodiment;

FIG. 9 is a diagram that illustrates one example of a flowchart of a protection data generability assessment process according to the first embodiment;

FIG. 10 is a function block diagram that illustrates a configuration of the authentication system according to a second embodiment;

FIGS. 11A and 11B are diagrams that illustrate one example of a flowchart of the salt generation process according to the second embodiment;

FIG. 12 is a function block diagram that illustrates a configuration of the authentication system according to a third embodiment;

FIG. 13 is a diagram that illustrates one example of a flowchart of the protection data generability assessment process according to the third embodiment;

FIG. 14 is a function block diagram that illustrates a configuration of the authentication system according to a fourth embodiment;

FIG. 15 is a function block diagram that illustrates a configuration of the authentication system according to a fifth embodiment;

FIG. 16 is a diagram that illustrates one example of the salt management table according to the fifth embodiment; and

FIG. 17 is a diagram that illustrates one example of a computer that executes an authentication program.

### DESCRIPTION OF EMBODIMENTS

There is a problem in that template protection techniques in related art may not inhibit an impersonation attack by an attacker in a case where a conversion parameter is falsified.

For example, in one example of the template protection techniques, a client terminal generates arbitrary biometric protection data by using the conversion parameter falsified by an attacker, the impersonation attack thereby becomes possible, and the impersonation attack may not be inhibited.

In another example of the template protection techniques, a parameter management server generates the conversion parameter and transmits the generated conversion parameter to the client terminal. Consequently, in a case where the conversion parameter is falsified when the conversion parameter is transmitted from the parameter management server to the client terminal, the client terminal generates arbitrary biometric protection data by using a false conversion parameter and false biometric data. As a result, the impersonation attack by an attacker may not be inhibited.

It is desirable to inhibit an impersonation attack by falsification of a conversion parameter in a template protection technique.

### First Embodiment

[Configuration of Authentication System According to Embodiment]

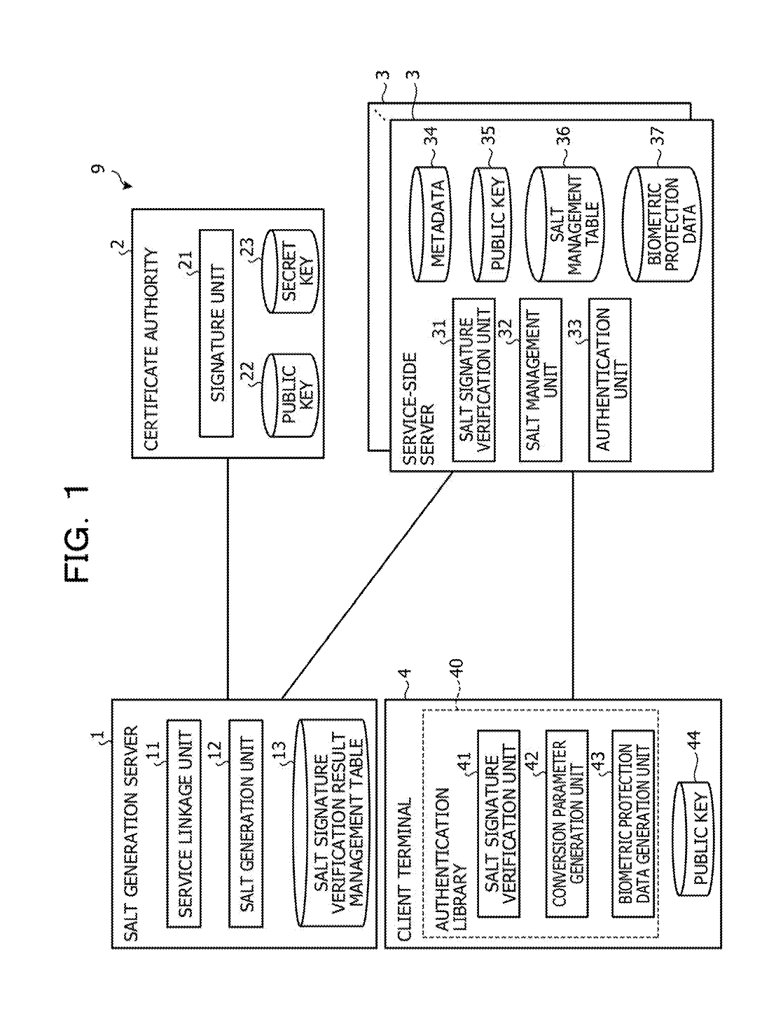

FIG. 1 is a function block diagram that illustrates a configuration of an authentication system according to a first embodiment. An authentication system 9 illustrated in FIG. 1 includes a biometric template protection function in which biometric protection data (template) which are referred to as template and are generated from biometric data are registered, the biometric data acquired in authentication are compared with converted data, and identity is thereby confirmed. A service-side server manages a signed salt of a salt, which is the original data of a conversion parameter used in template protection, in order to authenticate the biometric protection data of a client that accesses the service. Thus, the authentication system 9 causes a reliable certificate authority to sign the salt used in the template protection in a case where a service-side server is added and enables distribution of the signed salt to the service-side server only in a case where signature verification succeeds. Note that “conversion parameter” mentioned here is a parameter that is used in a case of converting the biometric data to the biometric protection data. “Salt” is the original data for generation of the conversion parameter and is expressed by a random number that is obtained by a pseudo-random number generator, for example.

The authentication system 9 has a salt generation server 1, a certificate authority 2, a service-side server 3, and a client terminal 4.

The salt generation server 1 generates the salt that corresponds to a service and delivers the generated salt to the service-side server 3 that provides the service. The salt generation server 1 has a service linkage unit 11, a salt generation unit 12, and a salt signature verification result management table 13. Note that the salt generation unit 12 is one example of a generation unit and a distribution unit.

In a case where the service linkage unit 11 causes the service-side server 3 that provides a new service to be linked with the salt generation server 1, the service linkage unit 11 acquires identification information of the service from the service-side server 3 to be linked. Then, the service linkage unit 11 passes the acquired identification information to the salt generation unit 12. The identification information mentioned here includes an address of the service, for example. The address of the service is included in metadata.

The salt generation unit 12 generates the salt that corresponds to the service. For example, the salt generation unit 12 passes the identification information of the service, which is passed from the service linkage unit 11, as the parameter to the pseudo-random number generator and generates an output random number as the salt.

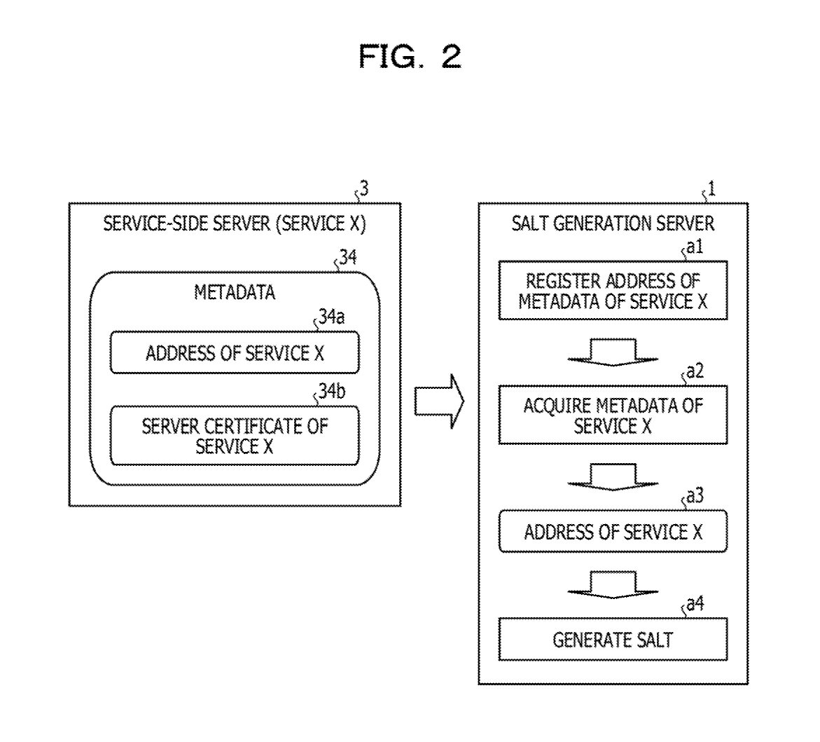

Here, one example of salt generation will be described with reference to FIG. 2. Note that FIG. 2 illustrates a case where the salt generation server 1 is linked with a new service X. FIG. 2 is a diagram for explaining one example of salt generation according to the first embodiment. As illustrated in FIG. 2, the service linkage unit 11 registers the address at which metadata 34 of the new service X are present (a1). The service linkage unit 11 acquires the metadata 34 of the service X from the address of the registered service X (a2) and passes the metadata 34 to the salt generation unit 12. The metadata 34 mentioned here include an address 34a of the service X and a server certificate 34b of the service X. Then, the salt generation unit 12 passes the address 34a of the service X, which is included in the metadata 34 passed from the service linkage unit 11, as the parameter to the pseudo-random number generator (a3) and generates an output random number as the salt (a4). Note that the salt generation unit 12 may generate the salt by using a common name included in the server certificate 34b of the service X instead of the address 34a of the service X.

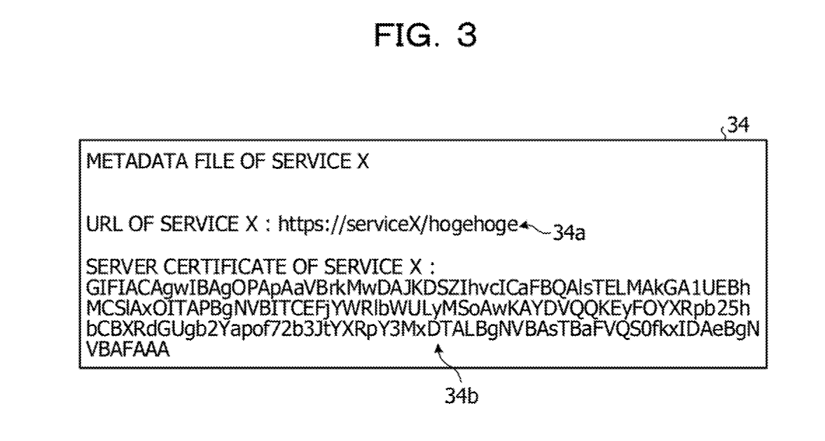

Here, one example of the metadata 34 of the service X will be described with reference to FIG. 3. FIG. 3 is a diagram that illustrates one example of the metadata. As illustrated in FIG. 3, in a metadata file of the service X, a Uniform Resource Locator (URL) “https: . . . ” of the service X is set as the address 34a of the service X. “GIFIACAgw . . . ” is set as the server certificate 34b of the service X.

Returning to FIG. 1, further, the salt generation unit 12 requests the certificate authority 2 to sign the generated salt. The salt generation unit 12 distributes the salt, which is signed, to the service-side server 3 that provides the service. Then, the salt generation unit 12 records a distribution destination and a distribution history of the signed salt, which are associated with the service, in the salt signature verification result management table 13.

Further, in a case where the salt generation unit 12 accepts a signature verification result of a signature salt from the service-side server 3, the salt generation unit 12 records the signature verification result, which is associated with the service, in the salt signature verification result management table 13.

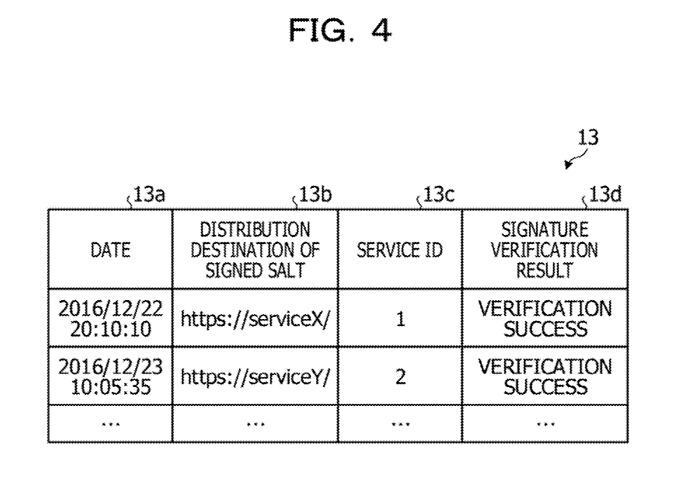

The salt signature verification result management table 13 manages the distribution history in a case where the signed salt is distributed to the service-side server 3 and a verification result of the signed salt in the service-side server 3. Here, one example of the salt signature verification result management table 13 will be described with reference to FIG. 4.

FIG. 4 is a diagram that illustrates one example of a salt signature verification result management table according to the first embodiment. As illustrated in FIG. 4, the salt signature verification result management table 13 stores a date 13a, a distribution destination 13b of the signed salt, a service ID 13c, and a signature verification result 13d, which are associated together. The date 13a is a date when the signed salt is distributed or a date when the signature verification result of the signed salt is accepted. The distribution destination 13b of the signed salt indicates the address of the service to which the signed salt is distributed. As one example of the address of the service, the URL of the service is raised. The service identifier (ID) 13c indicates an identifier that uniquely identifies the service. The signature verification result 13d indicates a result of verification about the signed salt by the service-side server 3 that provides the service. In other words, the signature verification result 13d indicates a distribution result of the distribution of the signed salt from the salt generation server 1 to the service-side server 3. As one example, in a case where the verification of the signature succeeds, “verification success” is stored in the signature verification result 13d. In a case where the verification of the signature fails, “verification failure” is stored in the signature verification result 13d.

As one example, in a case where the date 13a is “2016/12/22 20:10:10”, “https://serviceX/” is stored as the distribution destination 13b of the signed salt, “1” is stored as the service ID 13c, and “verification success” is stored as the signature verification result 13d.

Returning to FIG. 1, the certificate authority 2 signs the salt. For example, the certificate authority 2 is a trusted third party (TTP), which is reliable about electronic authentication. The certificate authority 2 has a signature unit 21 and manages a public key 22 and a secret key 23.

In a case where the signature unit 21 accepts a request for a signature for the salt from the salt generation server 1, the signature unit 21 signs the salt by using the secret key 23. Then, the signature unit 21 transmits the signed salt to the salt generation server 1.

The service-side server 3 manages the salt and authenticates the biometric protection data that are generated by using the salt. The service-side server 3 has a salt signature verification unit 31, a salt management unit 32, and an authentication unit 33. The service-side server 3 has the metadata 34, a public key 35, a salt management table 36, and biometric protection data 37. Note that the salt signature verification unit 31 is one example of a verification unit. The salt management unit 32 is one example of a management unit.

The service-side server 3 includes the metadata 34 for each service. The contents of the metadata 34 are described in FIG. 3, and a description thereof will thus not be made. The metadata 34 are transmitted to the salt generation server 1 based on a demand for service linkage by the salt generation server 1.

The public key 35 is the same as the public key 22 that is managed by the certificate authority 2.

The salt management table 36 manages the signed salt while associating it with the service and the salt. Note that a data structure of the salt management table 36 will be described later.

The biometric protection data 37 are stored for each user. Note that the biometric protection data 37 are generated by the client terminal 4.

The salt signature verification unit 31 verifies the signed salt. For example, in a case where the salt signature verification unit 31 accepts the signed salt from the salt generation server 1, the salt signature verification unit 31 verifies the signature of the signed salt by using the public key 35. Then, the salt signature verification unit 31 transmits the signature verification result to the salt generation server 1.

In a case where the signature verification succeeds, the salt management unit 32 manages the signed salt. For example, in a case where the salt signature verification unit 31 succeeds in the verification of the signature of the signed salt, the salt management unit 32 records the signed salt, which is associated with the service and the salt, in the salt management table 36.

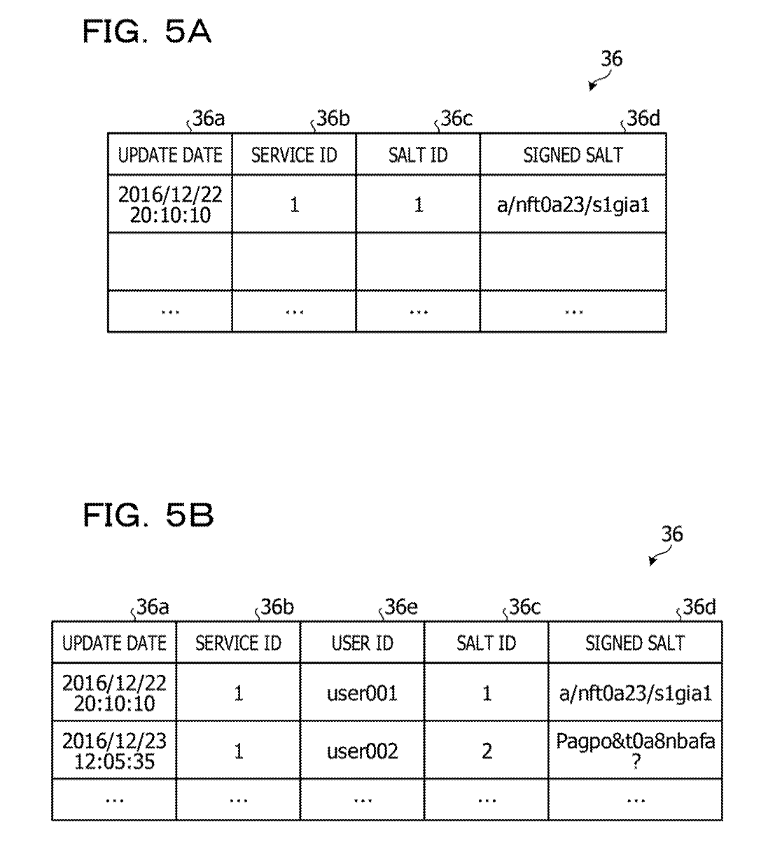

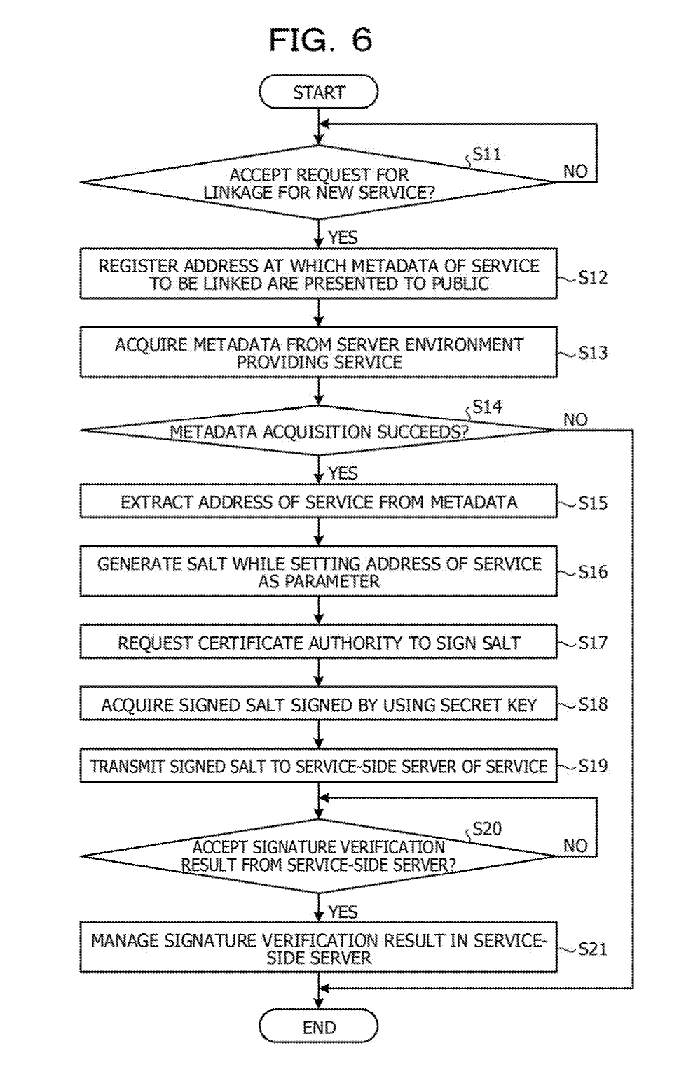

Here, one example of the salt management table 36 will be described with reference to FIG. 5A and FIG. 5B. FIG. 5A is a diagram that illustrates one example of a salt management table according to the first embodiment. As illustrated in FIG. 5A, the salt management table 36 stores an update date 36a, a service ID 36b, a salt ID 36c, and a signed salt 36d, which are associated together. The update date 36a indicates a date when this record is updated. The service ID 36b indicates an identifier that uniquely identifies the service. The service ID 36b corresponds to the service ID 13c in FIG. 4. The salt ID 36c indicates an identifier that uniquely identifies the salt. The signed salt 36d is a salt with a signature that succeeds in the signature verification.

As one example, in a case where the update date 36a is “2016/12/22 20:10:10”, “1” is stored as the service ID 36b, “1” is stored as the salt ID 36c, and “a/nft0a23/slgial” is stored as the signed salt 36d.

FIG. 5B is a diagram that illustrates another example of the salt management table according to the first embodiment. In FIG. 5A, a description is made about a case where the salt management table 36 manages the signed salt 36d for each of the service IDs 36b. In FIG. 5B, the salt management table 36 manages the signed salt 36d for each of the service IDs 36b and user IDs 36e. That is, this is a case where the salt management table 36 manages the salt for each of the users in addition to the services. As illustrated in FIG. 5B, the salt management table 36 stores the update date 36a, the service ID 36b, the user ID 36e, the salt ID 36c, and the signed salt 36d, which are associated together. The user ID 36e indicates an identifier that uniquely identifies the user.

As one example, in a case where the update date 36a is “2016/12/22 20:10:10”, “1” is stored as the service ID 36b, “user001” is stored as the user ID 36e, “1” is stored as the salt ID 36c, and “a/nft0a23/slgial” is stored as the signed salt 36d. With respect to the same service ID 36b, in a case where the update date 36a is “2016/12/23 12:05:35”, “user002” is stored as the user ID 36e, “2” is stored as the salt ID 36c, and “Pagpo&t0a8nbafa?” is stored as the signed salt 36d.

Note that types of biometric authentication may further be added to the salt management table 36. For example, fingerprint authentication, palm vein authentication, and so forth as the types of the biometric authentication may be added. Further, types of the biometric authentication and authentication targets may further be added to the salt management table 36. For example, fingerprint authentication as the type of the biometric authentication, the index finger of the right hand as the authentication target, and so forth may be added. Palm vein authentication as the type of the biometric authentication and the right hand as the authentication target may be added.

Returning to FIG. 1, in a case where the authentication unit 33 accepts the service ID transmitted from the client terminal 4, the authentication unit 33 refers to the salt management table 36, acquires the signed salt 36d that corresponds to the service ID, and transmits the acquired signed salt 36d to the client terminal 4.

Further, in a case where the authentication unit 33 accepts a registration process demand about the biometric protection data from the client terminal 4, the authentication unit 33 registers the biometric protection data of the user, which are transmitted from the client terminal 4, in a storage unit. Further, in a case where the authentication unit 33 accepts an authentication process demand about the biometric protection data from the client terminal 4, the authentication unit 33 compares the biometric protection data of the user, which are transmitted from the client terminal 4, with the registered biometric protection data 37 and authenticates the transmitted biometric protection data.

In a case where the client terminal 4 causes the service-side server 3 to register or authenticate the biometric protection data, the client terminal 4 acquires the signed salt from the service-side server 3 and generates the conversion parameter by using the salt that succeeds in the verification of the signature of the signed salt. Then, the client terminal 4 generates the biometric protection data by using the conversion parameter and the biometric data. The client terminal 4 has a salt signature verification unit 41, a conversion parameter generation unit 42, and a biometric protection data generation unit 43. Further, the client terminal 4 has a public key 44. Note that the salt signature verification unit 41, the conversion parameter generation unit 42, and the biometric protection data generation unit 43 are incorporated in an authentication library 40. Accordingly, the generated conversion parameter may be hidden in an internal portion of the authentication library 40. Further, the salt signature verification unit 41 is one example of a transmission unit and a reception unit. The conversion parameter generation unit 42 and the biometric protection data generation unit 43 are one example of a data generation unit. The biometric protection data generation unit 43 is one example of a demand unit.

The public key 44 is the same as the public key 22 that is managed by the certificate authority 2.

The salt signature verification unit 41 verifies the signed salt. For example, in a case where the salt signature verification unit 41 accepts a registration demand or an authentication demand about the biometric protection data, the salt signature verification unit 41 transmits the service ID of the concerned service to the service-side server 3 that provides a desired service and receives the signed salt, which corresponds to the service ID, from the service-side server 3. Then, the salt signature verification unit 41 verifies the signature of the received signed salt by using the public key 44. Then, in a case where the signature verification succeeds, the salt signature verification unit 41 passes the salt to the conversion parameter generation unit 42.

The conversion parameter generation unit 42 generates the conversion parameter while setting the salt that succeeds in the signature verification as the parameter.

The biometric protection data generation unit 43 generates the biometric protection data by using the conversion parameter, which is generated by the conversion parameter generation unit 42, and the biometric data. Note that the biometric data may be acquired from a biometric sensor that is built in or externally attached to the client terminal 4. As the biometric sensor, for example, a fingerprint sensor, a palm vein sensor, or the like is raised. Then, the biometric protection data generation unit 43 demands that the service-side server 3 performs a registration process or an authentication process about the biometric protection data, which include the generated biometric protection data, the service ID, and the user ID which uniquely identifies the user.

[Flowchart of Salt Generation Process on Salt Generation Server 1 Side]

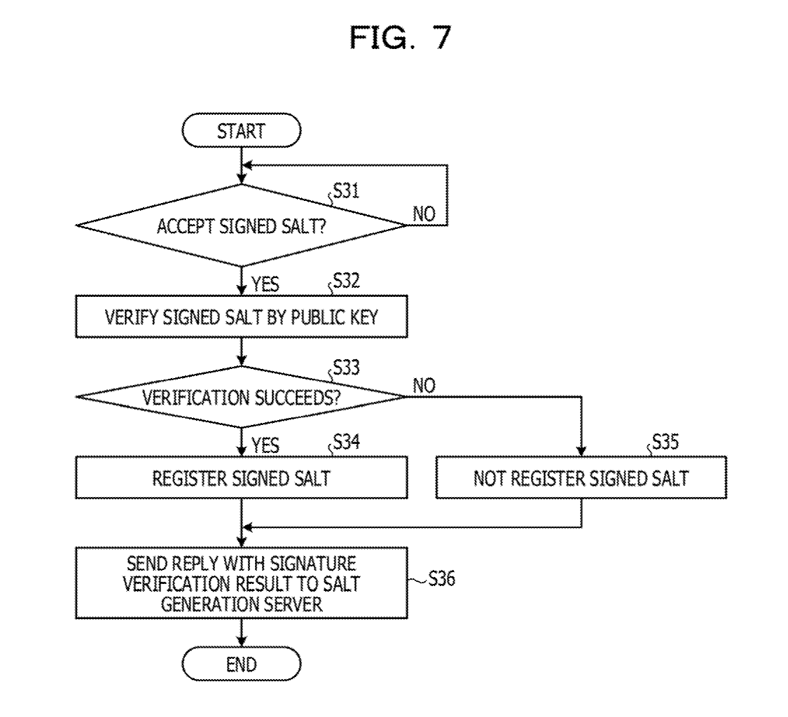

Here, a flowchart of a salt generation process on the salt generation server 1 side will be described with reference to FIG. 6. FIG. 6 is a diagram that illustrates one example of the flowchart of the salt generation process according to the first embodiment.

As illustrated in FIG. 6, the service linkage unit 11 assesses whether or not a request for linkage for a new service is accepted (step S11). In a case where the request for linkage for the new service is assessed as not accepted (step S11; No), the service linkage unit 11 repeats an assessment process until the request is accepted.

On the other hand, in a case where the request for linkage for the new service is assessed as accepted (step S11; Yes), the service linkage unit 11 registers the address at which the metadata of the service to be linked are presented to the public (step S12). Then, the service linkage unit 11 acquires the metadata from a server environment that provides the service (step S13).

The service linkage unit 11 assesses whether or not acquisition of the metadata succeeds (step S14). In a case where the acquisition of the metadata is assessed as not succeeding (step S14; No), the service linkage unit 11 finishes the salt generation process.

On the other hand, in a case where the acquisition of the metadata is assessed as succeeding (step S14; Yes), the salt generation unit 12 extracts the address of the service from the metadata (step S15). Then, the salt generation unit 12 generates the salt while setting the address of the service as the parameter (step S16). For example, the salt generation unit 12 passes the address of the service as the parameter to the pseudo-random number generator and generates an output random number as the salt.

Next, the salt generation unit 12 requests the certificate authority 2 to sign the salt (step S17). Then, the salt generation unit 12 acquires the signed salt that is signed by using the secret key 23 from the certificate authority 2 (step S18). The salt generation unit 12 transmits the signed salt to the service-side server 3 that provides the service (step S19).

Subsequently, the salt generation unit 12 assesses whether or not the signature verification result is accepted from the service-side server 3 (step S20). In a case where the signature verification result is assessed as not accepted (step S20; No), the salt generation unit 12 repeats an assessment process until the signature verification result is accepted.

On the other hand, in a case where the signature verification result is assessed as accepted (step S20; Yes), the salt generation unit 12 manages the signature verification result in the service-side server 3 (step S21). For example, the salt generation unit 12 records the signature verification result, which is associated with the service, with respect to the salt signature verification result management table 13. Then, the salt generation unit 12 finishes the salt generation process.

[Flowchart of Salt Management Process by Service-Side Server 3]

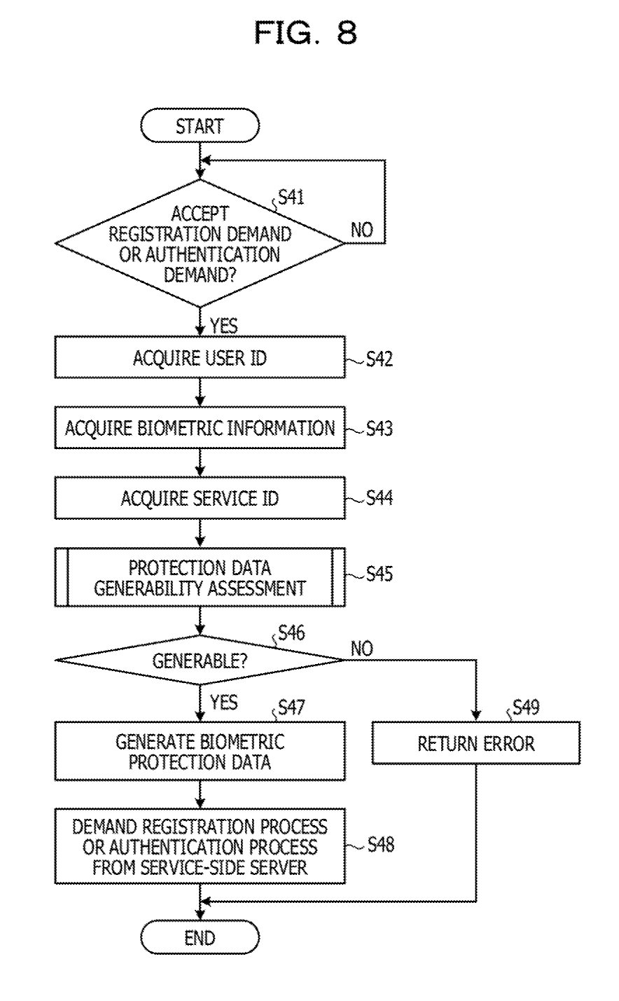

Here, a flowchart of a salt management process by the service-side server 3 will be described with reference to FIG. 7. FIG. 7 is a diagram that illustrates one example of the flowchart of the salt management process according to the first embodiment.

As illustrated in FIG. 7, the salt signature verification unit 31 assesses whether or not the signed salt is accepted (step S31). In a case where the signed salt is assessed as not accepted (step S31; No), the salt signature verification unit 31 repeats an assessment process until the signed salt is accepted.

On the other hand, in a case where the singed salt is assessed as accepted (step S31; Yes), the salt signature verification unit 31 verifies the signed salt by the public key 35 (step S32). The salt management unit 32 assesses whether or not the verification succeeds (step S33). In a case where the verification is assessed as succeeding (step S33; Yes), the salt management unit 32 registers the signed salt, which is associated with the service and the salt, in the salt management table 36 (step S34). Then, the salt management unit 32 moves to step S36.

On the other hand, in a case where the verification is assessed as not succeeding (step S33; No), the salt management unit 32 does not register the signed salt in the salt management table 36 (step S35). Then, the salt management unit 32 moves to step S36.

In step S36, the salt management unit 32 sends a reply with the signature verification result to the salt generation server 1 (step S36). Then, the salt management unit 32 finishes the salt management process.

[Flowchart of Biometric Protection Data Generation Process by Client Terminal 4]

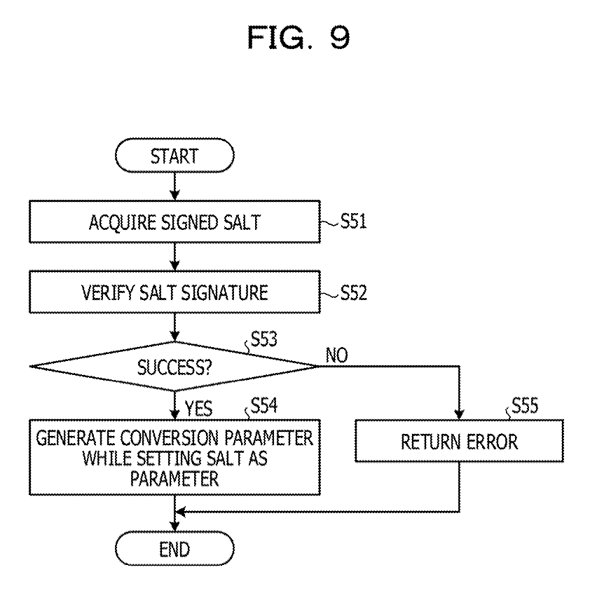

Here, a flowchart of a biometric protection data generation process by the client terminal 4 will be described with reference to FIG. 8. FIG. 8 is a diagram that illustrates one example of the flowchart of the biometric protection data generation process according to the first embodiment.

As illustrated in FIG. 8, the salt signature verification unit 41 assesses whether or not the registration demand or the authentication demand about the biometric protection data is accepted from the user (step S41). In a case where the registration demand or the authentication demand is assessed as not accepted (step S41; No), the salt signature verification unit 41 repeats an assessment process until the registration demand or the authentication demand is accepted.

On the other hand, in a case where the registration demand or the authentication demand is assessed as accepted (step S41; Yes), the salt signature verification unit 41 acquires the user ID of the user who makes the demand (step S42). For example, the registration demand or the authentication demand includes biometric information of the user, the user ID of the user, and the service ID of the service that is desired to be provided, for example. In such a case, the salt signature verification unit 41 acquires the user ID from the registration demand or the authentication demand.

Then, the salt signature verification unit 41 acquires the biometric information (step S43). For example, the salt signature verification unit 41 acquires the biometric information from the registration demand or the authentication demand.

Then, the salt signature verification unit 41 acquires the service ID of the concerned service of the service-side server 3 that provides a desired service (step S44). For example, the salt signature verification unit 41 acquires the service ID from the registration demand or the authentication demand.

Then, the salt signature verification unit 41 executes a protection data generability assessment process (step S45). Note that a flowchart of the protection data generability assessment process will be described later.

Then, the biometric protection data generation unit 43 assesses whether or not the biometric protection data are generable (step S46). In a case where the biometric protection data are assessed as generable (step S46; Yes), the biometric protection data generation unit 43 generates the biometric protection data by using the generated conversion parameter and the biometric information (step S47).

Then, the biometric protection data generation unit 43 demands that the service-side server 3 that corresponds to the service ID performs the registration process or the authentication process about the biometric protection data, which include the generated biometric protection data and the user ID (step S48). Then, the biometric protection data generation unit 43 finishes the biometric protection data generation process.

On the other hand, in a case where the biometric protection data are assessed as not generable (step S46; No), the biometric protection data generation unit 43 returns an error (step S49). Then, the biometric protection data generation unit 43 finishes the biometric protection data generation process.

[Flowchart of Protection Data Generability Assessment Process by Client Terminal 4]

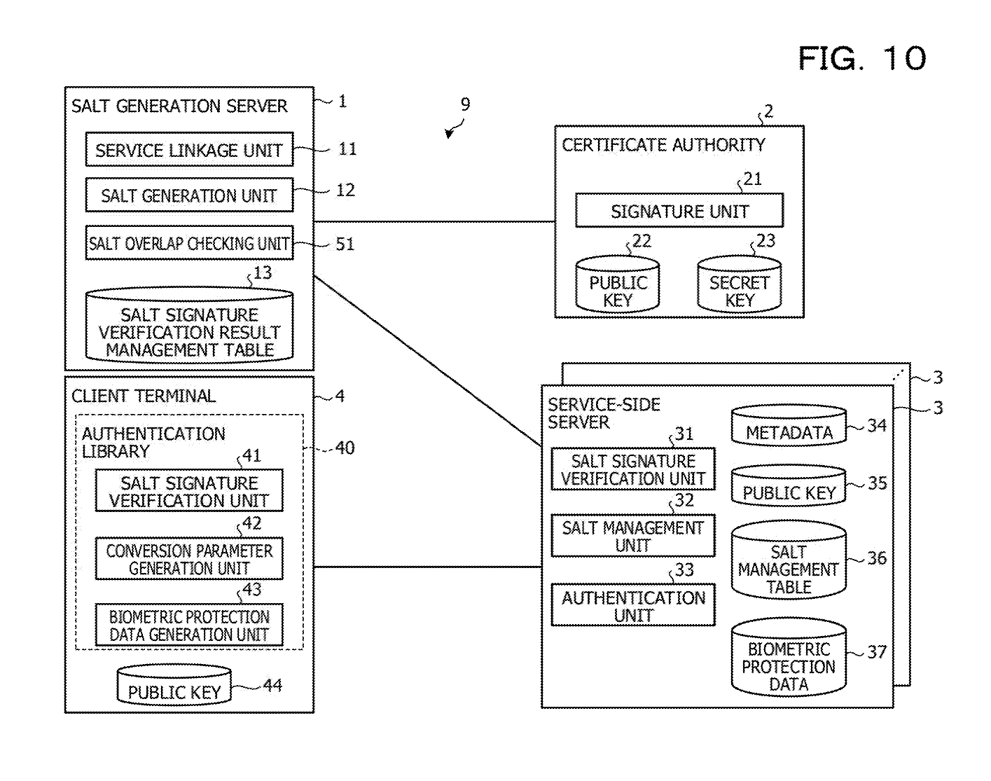

Here, a flowchart of the protection data generability assessment process by the client terminal 4 will be described with reference to FIG. 9. FIG. 9 is a diagram that illustrates one example of the flowchart of the protection data generability assessment process according to the first embodiment.

As illustrated in FIG. 9, the salt signature verification unit 41 acquires the signed salt from the service-side server 3 that corresponds to the service ID (step S51). The salt signature verification unit 41 verifies the signature of the acquired signed salt by using the public key 44 (step S52).

The salt signature verification unit 41 assesses whether or not the verification succeeds (step S53). In a case where the verification is assessed as succeeding (step S53; Yes), the conversion parameter generation unit 42 generates the conversion parameter while setting the salt as the parameter (step S54). Then, the conversion parameter generation unit 42 returns a fact that the biometric protection data are generable together with the generated conversion parameter to the biometric protection data generation process.

On the other hand, in a case where the verification is assessed as not succeeding (step S53; No), the conversion parameter generation unit 42 returns an error to the biometric protection data generation process (step S55). That is, the conversion parameter generation unit 42 returns a fact that the biometric protection data are not generable to the biometric protection data generation process.

### Effects of First Embodiment

In such a manner, in the above first embodiment, the salt generation server 1 generates a random number salt, which is a random number salt which is obtained by setting the identification information of the service provided by the service-side server 3 as the parameter and is used for generating the conversion parameter. The salt generation server 1 distributes a signature random number salt, which results from signing of the generated random number salt by using the secret key 23, to the service-side server 3. The service-side server 3 verifies the signature of the signature random number salt by using the public key 35 that corresponds to the secret key 23. In a case where the service-side server 3 succeeds in the verification of the signature of the signature random number salt, the service-side server 3 manages the signature random number salt. In such a configuration, the salt generation server 1 centrally generates the random number salt of the service-side server 3 and transmits the random number salt, which is signed, to the service-side server 3, and falsification of the random number salt as the original data of the conversion parameter used for generating the biometric protection data may thereby be hindered. As a result, the salt generation server 1 may inhibit falsification of the random number salt and further an impersonation attack by falsification of the conversion parameter. In other words, the salt generation server 1 may inhibit exposure to the impersonation attack by the biometric protection data that are generated by using a false random number salt.

Further, in the above first embodiment, in a case where the biometric protection data of the client are registered or authenticated, the client terminal 4 transmits the identification information of the service to the service-side server 3 that provides a desired service. The client terminal 4 receives the signature random number salt that corresponds to the identification information of the service from the service-side server 3. Then, the client terminal 4 verifies the signature of the signature random number salt by using the public key 44 that corresponds to the secret key 23. In a case where the verification of the signature of the signature random number salt succeeds, the client terminal 4 generates the biometric protection data by using the random number salt. The client terminal 4 demands registration or authentication of the generated biometric protection data from the service-side server 3. In such a configuration, the client terminal 4 may inhibit falsification of the random number salt and further the impersonation attack by falsification of the conversion parameter. In other words, because the client terminal 4 does not generate false biometric protection data by using a false random number salt, the impersonation attack may be inhibited.

Further, in the above first embodiment, the client terminal 4 executes a function of generating the conversion parameter by using the random number salt and of generating the biometric protection data by using the generated conversion parameter in the internal portion of the authentication library 40. In such a configuration, the client terminal 4 may hide the conversion parameter in the internal portion of the authentication library 40 and may thereby inhibit the impersonation attack by falsification of the conversion parameter.

### Second Embodiment

Incidentally, in the first embodiment, a description is made about a case where in the salt generation server 1, the salt generation unit 12 generates the salt of a random number while setting the identification information of a new service to be linked as the parameter. However, the salt generation unit 12 is not limited to this but may collect the salts that have been already distributed, check for overlap of a newly generated salt, and, in a case where overlap occurs, regenerate the salt of a random number until no overlap occurs.

Accordingly, in a second embodiment, a description will be made about a case where the salt generation unit 12 collects the salts that have been already distributed, checks for overlap of a newly generated salt, and, in a case where overlap occurs, regenerates the salt of a random number until no overlap occurs.

[Configuration of Authentication System According to Second Embodiment]

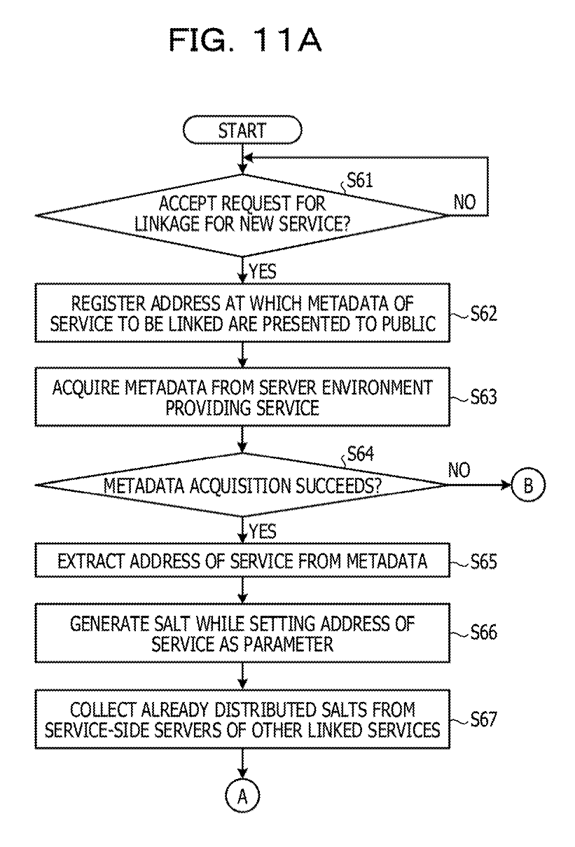

FIG. 10 is a function block diagram that illustrates a configuration of the authentication system according to the second embodiment. Note that the same reference numerals will be indicated for the same configurations as the configurations of the authentication system 9 illustrated in FIG. 1, and descriptions of the overlapping configurations and actions will thereby not be made. The difference between the first embodiment and the second embodiment is a point that a salt overlap checking unit 51 is added to the salt generation server 1. Note that the salt overlap checking unit 51 is one example of the generation unit.

The salt overlap checking unit 51 performs an overlap check about the salt that is newly generated by the salt generation unit 12. For example, the salt overlap checking unit 51 collects the already distributed salts from the service-side servers 3 that provide the services which are already linked with the salt generation server 1. The salt overlap checking unit 51 checks whether or not the newly generated salt overlaps with the collected salts.

In a case where no overlap occurs, the salt overlap checking unit 51 notifies the salt generation unit 12 of a fact that no overlap occurs. Subsequently, the salt generation unit 12 requests the certificate authority 2 to sign the generated salt and distributes the salt, which is signed, (the signed salt) to the service-side server 3 that provides the service to be newly linked.

In a case where overlap occurs, the salt overlap checking unit 51 passes information in which numbers or a character string are added to the identification information of the service to the salt generation unit 12. Subsequently, the salt generation unit 12 passes the information passed from the salt overlap checking unit 51 as the parameter to the pseudo-random number generator and regenerates an output random number as the salt. That is, the salt generation unit 12 repeats generation of the salt until overlap of the generated salt does not occur any more.

[Flowchart of Salt Generation Process on Salt Generation Server 1 Side]

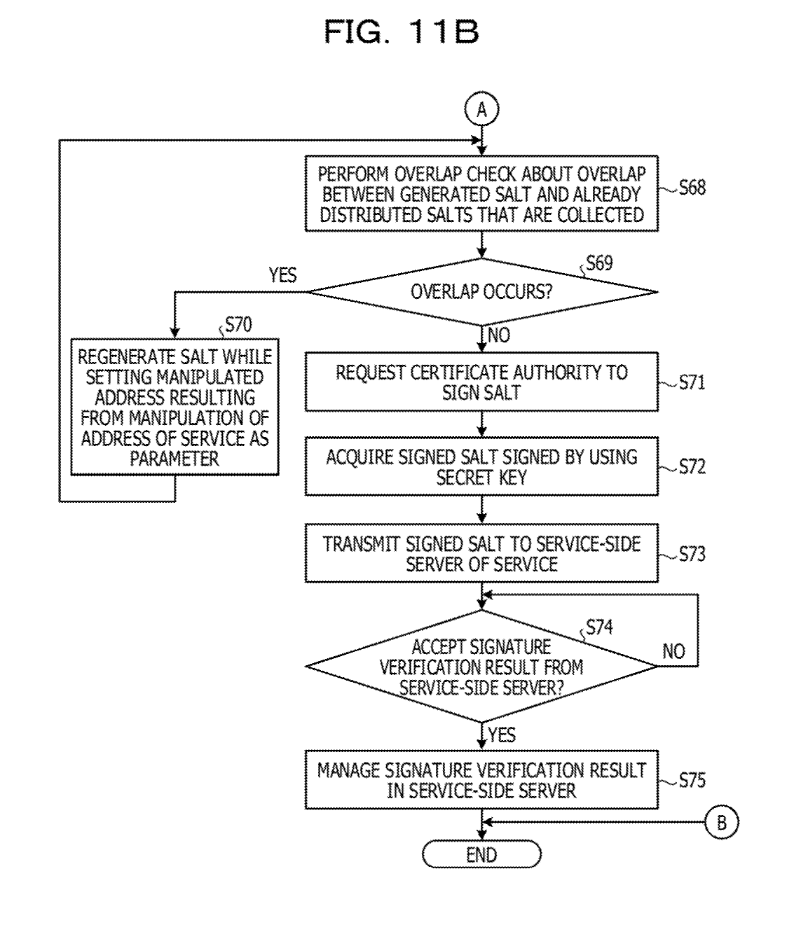

Here, a flowchart of a salt generation process on the salt generation server 1 side will be described with reference to FIGS. 11A and 11B. FIGS. 11A and 11B are diagrams that illustrate one example of the flowchart of the salt generation process according to the second embodiment. Note that steps S61 to S66 in FIG. 11A are similar to steps S11 to S16 in FIG. 6, and descriptions thereof will thus be simplified. Steps S71 to S75 in FIG. 11B are similar to steps S17 to S21 in FIG. 6, and descriptions thereof will thus be simplified. The parts that are different between FIG. 6 and FIGS. 11A and 11B are steps S67 to S70.

As illustrated in FIGS. 11A and 11B, the service linkage unit 11 assesses whether or not a request for linkage for a new service is accepted (step S61). In a case where the request for linkage for the new service is assessed as not accepted (step S61; No), the service linkage unit 11 repeats the assessment process until the request is accepted.

On the other hand, in a case where the request for linkage for the new service is assessed as accepted (step S61; Yes), the service linkage unit 11 registers the address at which the metadata of the service to be linked are presented to the public (step S62). Then, the service linkage unit 11 acquires the metadata from a server environment that provides the service (step S63).

The service linkage unit 11 assesses whether or not acquisition of the metadata succeeds (step S64). In a case where the acquisition of the metadata is assessed as not succeeding (step S64; No), the service linkage unit 11 finishes the salt generation process.

On the other hand, in a case where the acquisition of the metadata is assessed as succeeding (step S64; Yes), the salt generation unit 12 extracts the address of the service from the metadata (step S65). Then, the salt generation unit 12 generates the salt while setting the address of the service as the parameter (step S66).

Next, the salt overlap checking unit 51 collects the already distributed salts from the service-side servers 3 that provide the other linked services (step S67). Then, the salt overlap checking unit 51 performs the overlap check about overlap between the generated salt and the already distributed salts that are collected (step S68). The salt overlap checking unit 51 assesses whether or not overlap occurs (step S69).

In a case where overlap is assessed as occurring (step S69; Yes), the salt generation unit 12 regenerates the salt while setting a manipulated address, which results from manipulation of the address of the service, as the parameter (step S70). For example, the salt generation unit 12 regenerates the salt while setting the information, in which numbers and a character string are added to the address of the service, as the parameter. Then, the salt generation unit 12 moves to step S68 in order to cause the salt overlap checking unit 51 to perform the overlap check about the regenerated salt.

On the other hand, in a case where overlap is assessed as not occurring (step S69; No), the salt generation unit 12 requests the certificate authority 2 to sign the salt (step S71). Then, the salt generation unit 12 acquires the signed salt that is signed by using the secret key 23 from the certificate authority 2 (step S72). The salt generation unit 12 transmits the signed salt to the service-side server 3 that provides the service (step S73).

Subsequently, the salt generation unit 12 assesses whether or not the signature verification result is accepted from the service-side server 3 (step S74). In a case where the signature verification result is assessed as not accepted (step S74; No), the salt generation unit 12 repeats the assessment process until the signature verification result is accepted.

On the other hand, in a case where the signature verification result is assessed as accepted (step S74; Yes), the salt generation unit 12 manages the signature verification result in the service-side server 3 (step S75). For example, the salt generation unit 12 records the signature verification result, which is associated with the service, with respect to the salt signature verification result management table 13. Then, the salt generation unit 12 finishes the salt generation process.

### Effects of Second Embodiment

In such a manner, in the above second embodiment, in a case where the request for linkage for a new service is accepted, the salt generation server 1 generates the salt of a random number, for which the identification information of the service provided by the service-side server 3 which corresponds to the new service is set as the parameter. Then, the salt generation server 1 collects the random number salts from the other service-side servers 3, which are different from the service-side server 3 which corresponds to the new service. Then, the salt generation server 1 uses the collected random number salts to check for overlap with the generated random number salt and regenerates a random number salt until no overlap occurs. In such a configuration, the salt generation server 1 checks for overlap of the random number salts among the plural service-side servers 3 and may thereby perform detection of falsification of the random number salt efficiently and accurately.

### Third Embodiment

Incidentally, in the first and second embodiments, the salt signature verification unit 41 of the client terminal 4 receives the signed salt that corresponds to the service ID from the service-side server 3 that provides a desired service and verifies the signature of the received signed salt by using the public key 44. That is, the client terminal 4 verifies the signature of the signed salt between the client terminal 4 and the service-side server 3. However, the client terminal 4 is not limited to the verification between the client terminal 4 and the service-side server 3 but may further verify the signature of the signed salt between the client terminal 4 and the salt generation server 1.

Accordingly, in a third embodiment, a description will be made about a case where the client terminal 4 verifies the signature of the signed salt among the client terminal 4, the service-side server 3, and the salt generation server 1.

[Configuration of Authentication System According to Third Embodiment]

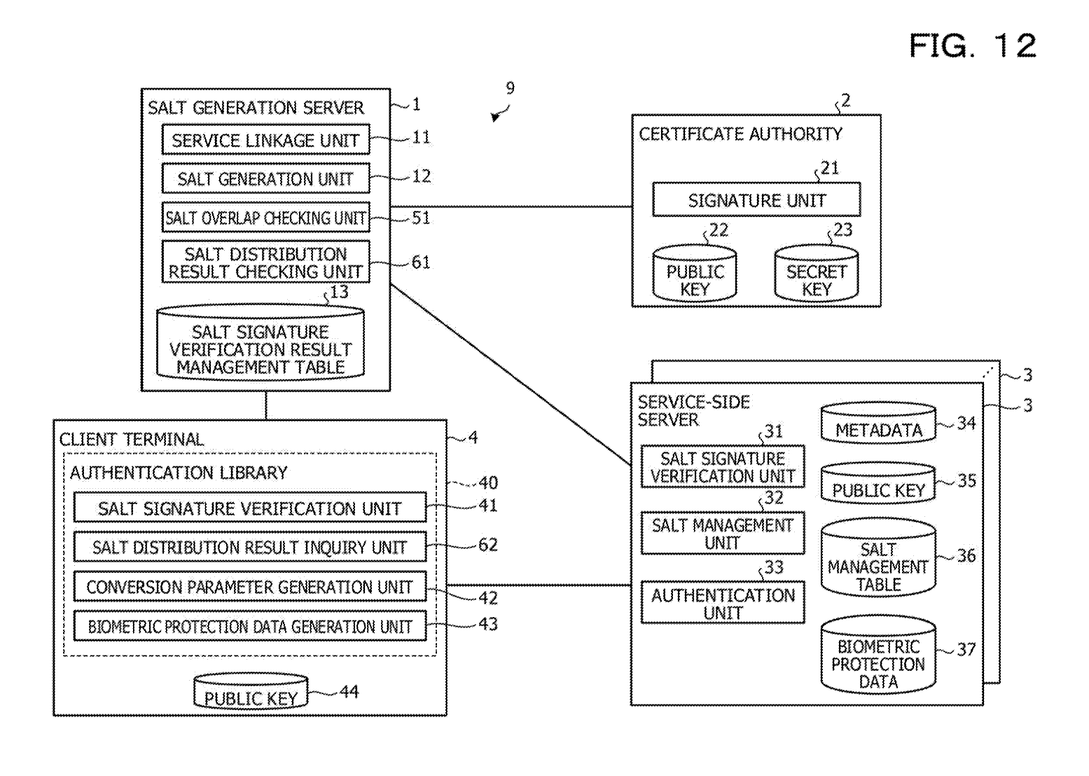

FIG. 12 is a function block diagram that illustrates a configuration of the authentication system according to the third embodiment. Note that the same reference numerals will be indicated for the same configurations as the configurations of the authentication system 9 illustrated in FIG. 1 and FIG. 10, and descriptions of the overlapping configurations and actions will thereby not be made. The difference between the first and second embodiments and the third embodiment is a point that a salt distribution result checking unit 61 is added to the salt generation server 1. Further, the difference is a point that a salt distribution result inquiry unit 62 is added to the client terminal 4. Note that the salt distribution result inquiry unit 62 is one example of the verification unit.

The salt distribution result checking unit 61 of the salt generation server 1 checks the distribution result of the salt from the salt generation server 1 to the service-side server 3. For example, in a case where the salt distribution result checking unit 61 accepts, from the client terminal 4, a checking request about the distribution result of the salt that corresponds to the service which is desired to be provided, the salt distribution result checking unit 61 refers to the salt signature verification result management table 13 and checks the distribution result of the salt. As one example, the salt distribution result checking unit 61 refers to the salt signature verification result management table 13 and acquires the signature verification result 13d that corresponds to the service ID included in the checking request. Then, the salt distribution result checking unit 61 notifies the client terminal 4 of the acquired signature verification result 13d as the distribution result of the salt. That is, in a case where the signature verification result 13d is “verification success”, the salt distribution result checking unit 61 notifies the client terminal 4 of a fact that the distribution result of the salt is a success. In a case where the signature verification result 13d is “verification failure”, the salt distribution result checking unit 61 notifies the client terminal 4 of a fact that the distribution result of the salt is failure.

The salt distribution result inquiry unit 62 of the client terminal 4 inquires of the salt generation server 1 the distribution result of the salt from the salt generation server 1 to the service-side server 3. For example, the salt distribution result inquiry unit 62 requests the salt generation server 1 to check the distribution result of the salt that corresponds to the service which is desired to be provided. The salt distribution result inquiry unit 62 acquires the distribution result of the salt from the salt generation server 1. Subsequently, in a case where the signature verification by the salt signature verification unit 41 succeeds and the distribution result of the salt from the salt generation server 1 is a success, the conversion parameter generation unit 42 generates the conversion parameter while setting the salt that succeeds in the signature verification as the parameter.

[Flowchart of Biometric Protection Data Generation Process by Client Terminal 4]

Because the flowchart of the biometric protection data generation process by the client terminal 4 is similar to FIG. 8, and a description thereof will not be made.

[Flowchart of Protection Data Generability Assessment Process by Client Terminal 4]

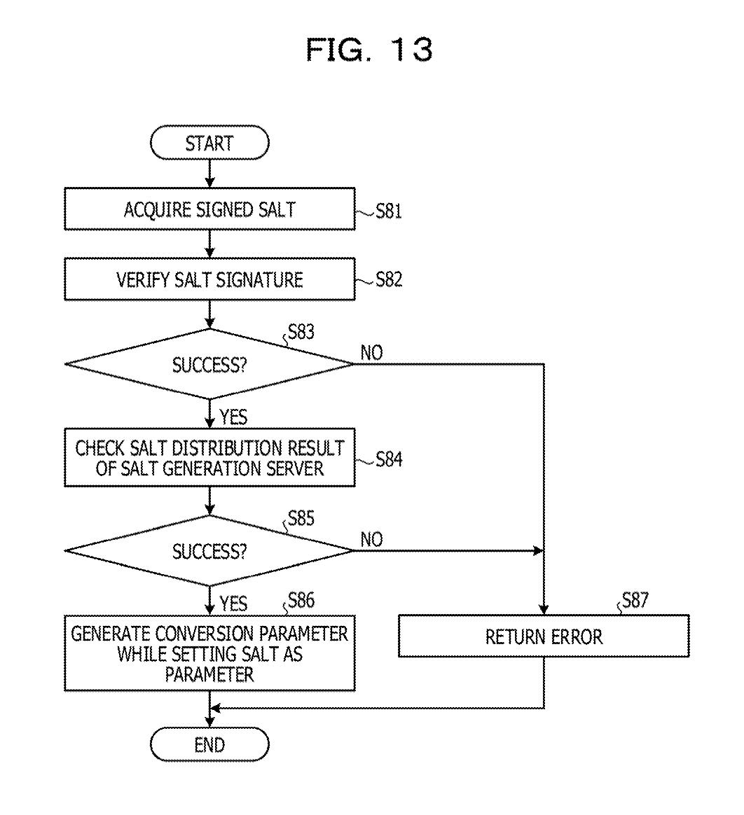

A flowchart of the protection data generability assessment process by the client terminal 4 will be described with reference to FIG. 13. FIG. 13 is a diagram that illustrates one example of the flowchart of the protection data generability assessment process according to the third embodiment. Note that steps S81 to S83, S86, and S87 in FIG. 13 are similar to steps S51 to S55 in FIG. 9, and descriptions thereof will thus be simplified. The parts that are different between FIG. 9 and FIG. 13 are steps S84 and S85.

As illustrated in FIG. 13, the salt signature verification unit 41 acquires the signed salt from the service-side server 3 that corresponds to the service ID (step S81). The salt signature verification unit 41 verifies the signature of the acquired signed salt by using the public key 44 (step S82).

The salt signature verification unit 41 assesses whether or not the verification succeeds (step S83). In a case where the verification is assessed as not succeeding (step S83; No), the salt signature verification unit 41 moves to step S87 in order to return an error to the biometric protection data generation process.

On the other hand, in a case where the verification is assessed as succeeding (step S83; Yes), the salt distribution result inquiry unit 62 checks the distribution result of the salt of the salt generation server 1 (step S84). For example, the salt distribution result inquiry unit 62 requests the salt generation server 1 to check the distribution result of the salt that corresponds to the service which is desired to be provided.

Then, in a case where the salt distribution result inquiry unit 62 accepts the distribution result of the salt from the salt generation server 1, the salt distribution result inquiry unit 62 assesses whether or not the salt distribution result is a success (step S85). In a case where the distribution result of the salt is assessed as a success (step S85; Yes), the conversion parameter generation unit 42 generates the conversion parameter while setting the salt as the parameter (step S86). Then, the conversion parameter generation unit 42 returns a fact that the biometric protection data are generable together with the generated conversion parameter to the biometric protection data generation process.

On the other hand, in a case where the distribution result of the salt is assessed as not a success (step S85; No), the conversion parameter generation unit 42 moves to step S87 in order to return an error to the biometric protection data generation process. In step S87, the salt signature verification unit 41 or the conversion parameter generation unit 42 returns an error to the biometric protection data generation process (step S87). That is, the salt signature verification unit 41 or the conversion parameter generation unit 42 returns a fact that the biometric protection data are not generable to the biometric protection data generation process.

### Effects of Third Embodiment

In such a manner, in the above third embodiment, the client terminal 4 verifies the signature of the signed salt that is transmitted from the service-side server 3 and requests the salt generation server 1 to check the distribution result of the signed salt to the service-side server 3. In a case where the verification of the signature of the signed salt succeeds and the distribution result of the signed salt is normal, the client terminal 4 generates the biometric protection data by using the salt. In such a configuration, the client terminal 4 verifies the signature of the signed salt among the client terminal 4, the service-side server 3, and the salt generation server 1 and thereby may further detect falsification of the salt accurately.

### Fourth Embodiment

Incidentally, in the first and second embodiments, a description is made about a case where the salt generation server 1 generates the salt that corresponds to the service and requests the certificate authority 2 to sign the generated salt. However, the salt generation server 1 is not limited to this, but the salt generation server 1 itself may sign the salt instead of requesting the certificate authority 2 to sign the salt.

Accordingly, in a fourth embodiment, a description will be made about a case where the salt generation server 1 itself signs the salt.

[Configuration of Authentication System According to Fourth Embodiment]

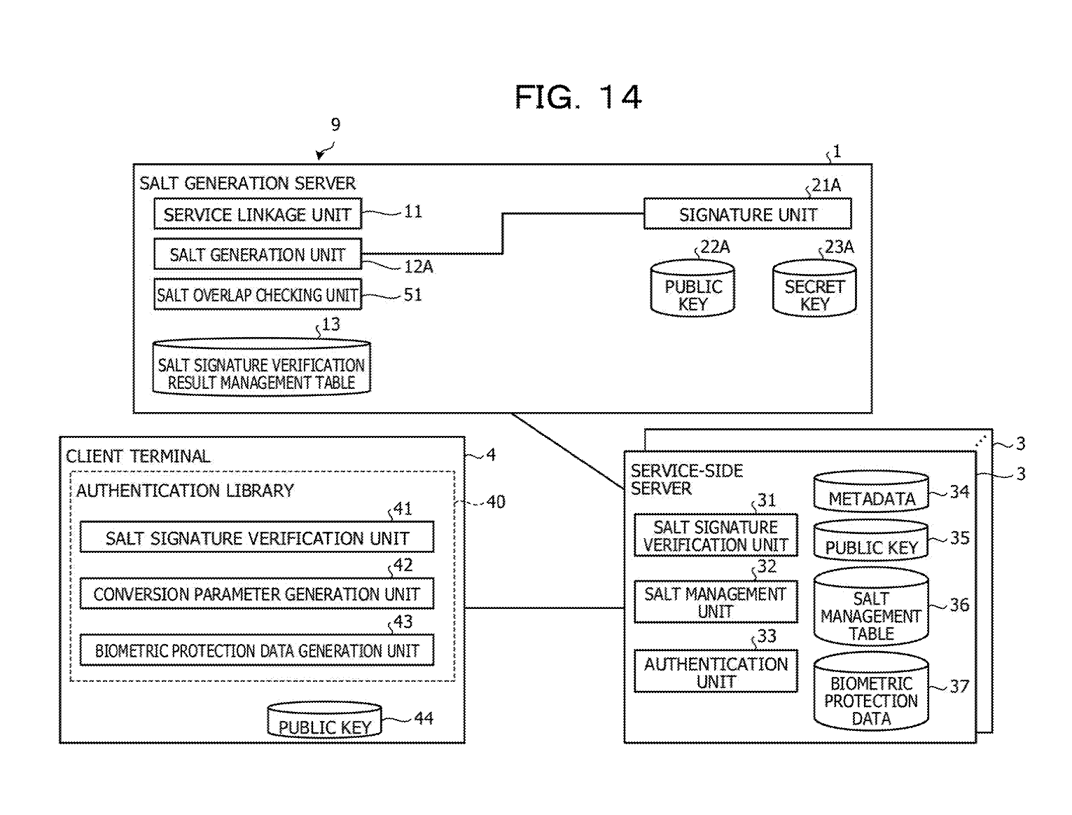

FIG. 14 is a function block diagram that illustrates a configuration of the authentication system according to the fourth embodiment. Note that the same reference numerals will be indicated for the same configurations as the configurations of the authentication system 9 illustrated in FIG. 10, and descriptions of the overlapping configurations and actions will thereby not be made. The difference between the second embodiment and the fourth embodiment is a point that the certificate authority 2 is removed. Further, the difference between the second embodiment and the fourth embodiment is a point that the salt generation unit 12 of the salt generation server 1 is changed to a salt generation unit 12A and a signature unit 21A, a public key 22A, and a secret key 23A are added to the salt generation server 1. That is, the salt generation server 1 manages the public key 22A and the secret key 23A.

The salt generation unit 12A generates the salt that corresponds to the service. For example, the salt generation unit 12A passes the identification information of the service, which is passed from the service linkage unit 11, as the parameter to the pseudo-random number generator and generates an output random number as the salt.

Further, the salt generation unit 12A requests the signature unit 21A to sign the generated salt. The salt generation unit 12A distributes the salt, which is signed, to the service-side server 3 that provides the service. Then, the salt generation unit 12A records the distribution destination and the distribution history of the signed salt, which are associated with the service, in the salt signature verification result management table 13.

Further, in a case where the salt generation unit 12A accepts the signature verification result of the signature salt from the service-side server 3, the salt generation unit 12A records the signature verification result, which is associated with the service, in the salt signature verification result management table 13.

In a case where the signature unit 21A accepts the request for the signature for the salt from the salt generation unit 12A, the signature unit 21A signs the salt by using the secret key 23A. Then, the signature unit 21A passes the signed salt to the salt generation unit 12A.

### Effects of Fourth Embodiment

In such a manner, in the above fourth embodiment, the salt generation server 1 signs the generated salt by using the secret key 23A managed by the salt generation server 1 itself and distributes the signed salt, which is signed, to the service-side server 3. In such a configuration, the salt generation server 1 itself signs the salt, and the running cost for the signature for the salt may be reduced. In addition, the salt generation server 1 may quickly generate the signed salt and quickly incorporate the signed salt in the service-side server 3.

### Fifth Embodiment

Incidentally, in the first to fourth embodiments, a description is made about a case where one server environment manages the salt of one service in the service-side server 3. However, the service-side server 3 is not limited to this, but one server environment may manage the salts of plural services.

Accordingly, in the fifth embodiment, a description will be made about a case where one server environment manages the salts of plural services in the service-side server 3.

[Configuration of Authentication System According to Fifth Embodiment]

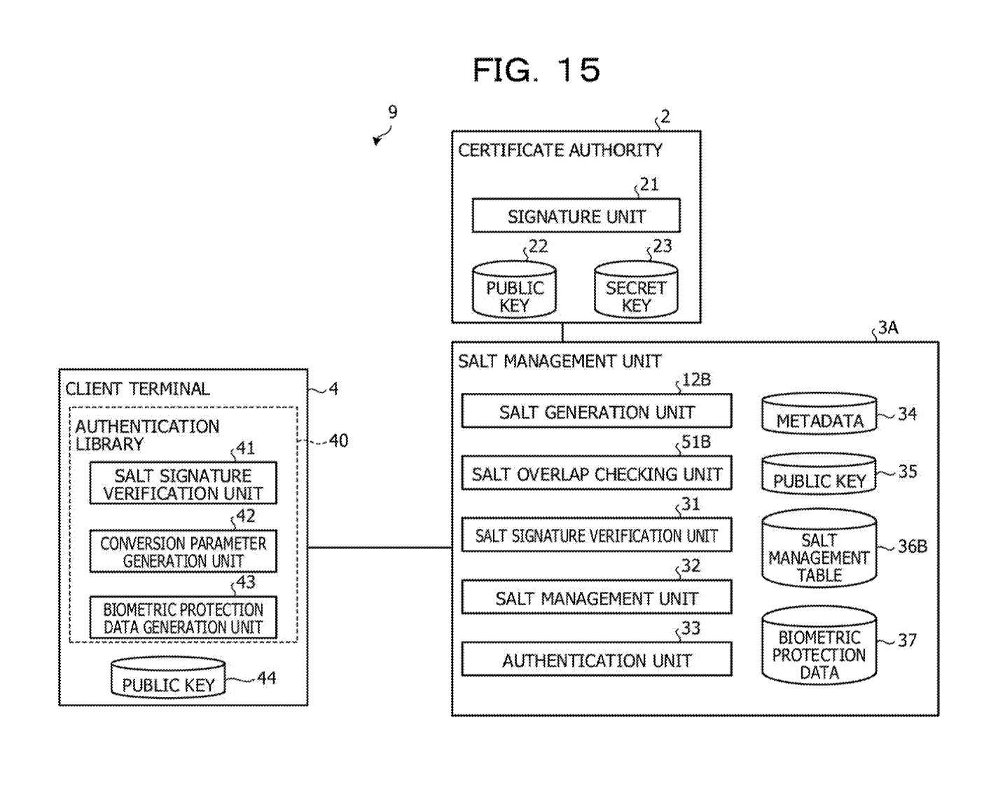

FIG. 15 is a function block diagram that illustrates a configuration of the authentication system according to the fifth embodiment. Note that the same reference numerals will be indicated for the same configurations as the configurations of the authentication system 9 illustrated in FIG. 1, and descriptions of the overlapping configurations and actions will thereby not be made. The difference between the first embodiment and the fifth embodiment is a point that the service-side server 3 is changed to a service-side server 3A and one service-side server 3A is provided. Further, the difference between the first embodiment and the fifth embodiment is a point that the functions of the salt generation server 1 are added to the service-side server 3A. That is, the difference is a point that a salt generation unit 12B and a salt overlap checking unit 51B are added to the service-side server 3A and the salt management table 36 is changed to a salt management table 36B.

The salt generation unit 12B generates the salt that corresponds to the service. For example, in a case where the salt generation unit 12B accepts the identification information of a newly added service from a manager, the salt generation unit 12B passes the accepted identification information as the parameter to the pseudo-random number generator and generates an output random number as the salt.

Further, the salt generation unit 12B causes the salt overlap checking unit 51B to check for overlap of the generated salt. In a case where overlap of the generated salt occurs, the salt generation unit 12B passes the information passed from the salt overlap checking unit 51B as the parameter to the pseudo-random number generator and regenerates an output random number as the salt. Then, the salt generation unit 12B causes the salt overlap checking unit 51B to check for overlap of the generated salt. The salt generation unit 12B repeats regeneration of the salt until overlap of the generated salt does not occur any more.

Further, in a case where overlap of the generated salt does not occur, the salt generation unit 12B requests the certificate authority 2 to sign the generated salt. Then, the salt generation unit 12B records the signed salt, which is associated with the service and the salt, in the salt management table 36B.

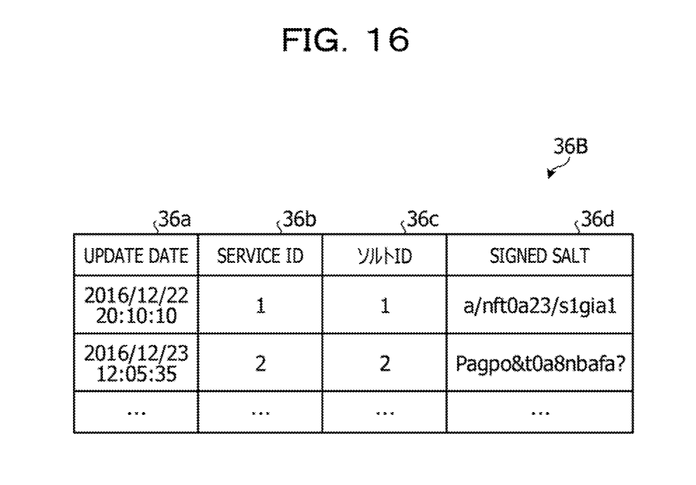

Here, one example of the salt management table 36B will be described with reference to FIG. 16. FIG. 16 is a diagram that illustrates one example of the salt management table according to the fifth embodiment. As illustrated in FIG. 16, the salt management table 36B stores the update date 36a, the service ID 36b, the salt ID 36c, and the signed salt 36d, which are associated together. The update date 36a indicates a date when this record is updated. The service ID 36b indicates an identifier that uniquely identifies the service. The service ID 36b is identification information of the service that is accepted from the manager, for example. The salt ID 36c indicates an identifier that uniquely identifies the salt. The signed salt 36d is the signed salt that is generated by the certificate authority 2.

As one example, in a case where the update date 36a is “2016/12/22 20:10:10”, “1” is stored as the service ID 36b, “1” is stored as the salt ID 36c, and “a/nft0a23/slgial” is stored as the signed salt 36d. In a case where the update date 36a is “2016/12/23 12:05:35”, “2” is stored as the service ID 36b, “2” is stored as the salt ID 36c, and “Pagpo&t0a8nbafa?” is stored as the signed salt 36d. That is, the salt management table 36B stores the signed salt 36d for each of the service IDs 36b.

Returning to FIG. 15, the salt overlap checking unit 51B performs the overlap check about the salt that is newly generated by the salt generation unit 12B. For example, the salt overlap checking unit 51B refers to the salt management table 36B and collects the already generated salts that are obtained from the signed salts. The salt overlap checking unit 51B checks whether the newly generated salt overlaps with the collected salts.

In a case where no overlap occurs, the salt overlap checking unit 51B notifies the salt generation unit 12B of a fact that no overlap occurs.

In a case where overlap occurs, the salt overlap checking unit 51B passes information in which numbers or a character string are added to the identification information of the service to the salt generation unit 12B.

### Effects of Fifth Embodiment

In such a manner, in the above fifth embodiment, the service-side server 3A generates the salt for which the identification information of a new service is set as the parameter. The service-side server 3A manages the signed salt, which results from signing of the generated salt by using the secret key 23, with respect to each of the services. In such a configuration, even in a case where the salt generation server 1 that centrally generates the salt is not provided, the service-side server 3A adds the signed salt, which is signed by using the secret key 23, does not add a false salt, and may thereby inhibit the impersonation attack.

[Other Matters]

Note that in the service-side server 3, in a case where the authentication unit 33 accepts the service ID transmitted from the client terminal 4, the authentication unit 33 acquires the signed salt 36d that corresponds to the service ID from the salt management table 36 and transmits the signed salt 36d to the client terminal 4. Further, a description is made about a case where when the authentication unit 33 accepts the authentication process demand about the biometric protection data from the client terminal 4, the authentication unit 33 compares the biometric protection data of the user, which are transmitted from the client terminal 4, with the registered biometric protection data 37 and authenticates the biometric protection data of the user. However, the authentication unit 33 may perform challenge-response authentication, which uses a challenge. For example, in a case where the authentication unit 33 accepts the service ID transmitted from the client terminal 4, the authentication unit 33 generates the challenge for which the service ID is set as the parameter and manages the challenge while relating the challenge with the service ID. Then, the authentication unit 33 acquires the signed salt 36d that corresponds to the service ID from the salt management table 36 and transmits the acquired signed salt 36d and the generated challenge to the client terminal 4. The client terminal 4 generates a response code while designating the biometric protection data, the challenge, and the salt as parameters of a one-way function. The client terminal 4 transmits the authentication process demand about the biometric protection data, which include the response code, the service ID, and the user ID, to the service-side server 3. In the service-side server 3, in a case where the authentication unit 33 accepts the authentication process demand about the biometric protection data from the client terminal 4, the authentication unit 33 generates authentication data while designating the challenge and salt related with the service ID and the biometric protection data related with the user ID as the parameters of a one-way function, compares the response code transmitted from the client terminal 4 with the generated authentication data, and authenticates the response code. That is, the authentication unit 33 authenticates the biometric protection data. Accordingly, the authentication unit 33 performs authentication by using the challenge in the authentication and thereby makes the response code and the authentication data as comparison targets become a one-time response code and one-time authentication data. Even in a case where the response code is falsified on a communication path, falsification may certainly be detected. As a result, the authentication unit 33 may inhibit exposure to the impersonation attack.

Further, in the embodiments, a description is made about a case where the salt generation unit 12 generates the salt that corresponds to the service. However, the salt generation unit 12 is not limited to this but may generate the salts that correspond to the service and the user. In such a case, the salt generation unit 12 may pass the identification information of the user (for example, the user ID) in addition to the identification information of the service (for example, the address) as the parameters to the pseudo-random number generator and generates output random numbers as the salts. Accordingly, the salt generation unit 12 may generate the salt for each of the services and users, and falsification of the salt for each of the services and users may be detected with respect to each of the users.

Further, the salt generation server 1 may be realized by installing the above-described service linkage unit 11, salt generation unit, and so forth in an information processing device such as a personal computer or a workstation, which has been known. The service-side server 3 may be realized by installing the above-described salt signature verification unit 31, salt management unit 32, authentication unit 33, and so forth in an information processing device such as a personal computer or a workstation, which has been known.

Further, the configuration elements of the devices of the authentication system 9, which are illustrated, do not necessarily have to be physically configured as illustrated. That is, specific manners of dispersion and integration of the devices are not limited to the manners in the illustrations. All or a portion thereof may be configured by functionally or physically dispersing or integrating those by any set in accordance with various kinds of loads, use situations, and so forth. For example, the salt generation unit 12 may be separated into a generation unit that generates the salt and a request unit that requests the certificate authority 2 to sign the salt. Further, the salt signature verification unit 31 and the salt management unit 32 may be integrated as one unit. Further, the storage unit that stores the salt signature verification result management table 13 may be coupled as an external device of the salt generation server 1 via a network.

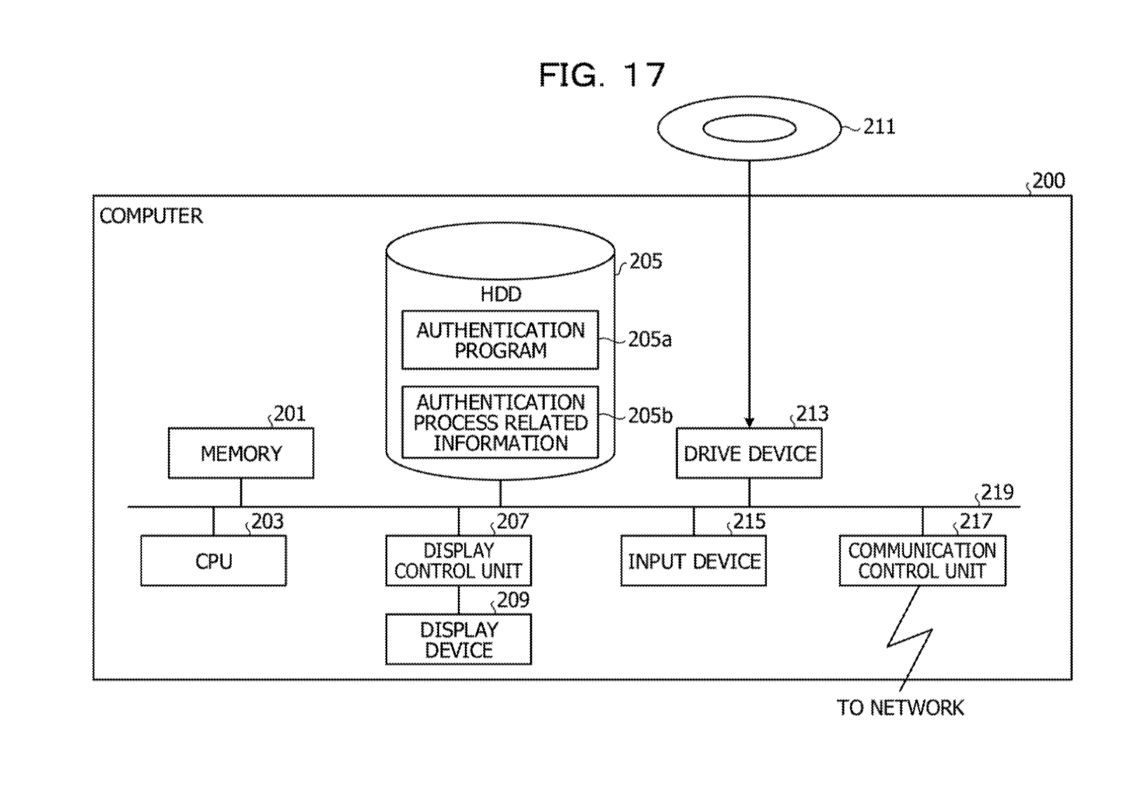

Further, various kinds of processes, which are described in the above embodiments, may be realized by executing a program that is prepared in advance by a computer such as a personal computer or a workstation. Accordingly, in the following, a description will be made about one example of a computer that executes an authentication program which realizes similar functions to the salt generation server 1 and the service-side server 3, which are illustrated in FIG. 1. FIG. 17 is a diagram that illustrates one example of the computer that executes the authentication program.

As illustrated in FIG. 17, a computer 200 has a CPU 203 that executes various kinds of computation processes, an input device 215 that accepts data inputs from the user, and a display control unit 207 that controls a display device 209. Further, the computer 200 has a drive device 213 that reads a program or the like from a storage medium and a communication control unit 217 that performs exchanges of data with another computer via a network. Further, the computer 200 has a memory 201 that temporarily stores various kinds of information and a hard disk drive (HDD) 205. Further, the memory 201, the CPU 203, the HDD 205, the display control unit 207, the drive device 213, the input device 215, and the communication control unit 217 are coupled together by a bus 219.

The drive device 213 is a device for a removable disk 211, for example. The HDD 205 stores an authentication program 205a and authentication process related information 205b.

The CPU 203 reads out the authentication program 205a, expands it in the memory 201, and executes it as processes. Such processes correspond to the function units of the salt generation server 1 and the service-side server 3. The authentication process related information 205b corresponds to the salt signature verification result management table 13 or the like. Further, the authentication process related information 205b corresponds to the salt management table 36 or the like. Further, for example, the removable disk 211 stores each piece of information such as the authentication program 205a.

Note that the authentication program 205a may not necessarily have to be initially stored in the HDD 205. For example, the program is stored in “portable physical media” such as a flexible disk (FD), a CD-ROM, a DVD disk, a magneto-optical disk, and an IC card, which are inserted in the computer 200. Then, the computer 200 may read out the authentication program 205a from those and execute it.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An authentication system configured to perform an authentication process by using a template generated from biometric data, the authentication system comprising:
a first server; and
a second server, wherein
the first server includes:
a first memory; and
a first processor coupled to the first memory and configured to:
generate, based on first identification information of a first service provided by the second server, a first random number used for generating the template from the biometric data;
generate a signature random number by electrical signing of the first random number by using a secret key; and
transmit the signature random number to the second server; and
the second server includes:
a second memory; and
a second processor coupled to the second memory and configured to:
verify the electrical signing by using a public key that corresponds to the secret key; and
store, into the second memory, the signature random number when verification of the electrical signing succeeds.

2. The authentication system according to claim 1, wherein
the biometric data are acquired by a terminal device,
when the second server receives the first identification information from the terminal device, the second processor is configured to transmit, to the terminal device, the signature random number corresponding to the first identification information, and
the terminal device is configured to:
verify the electrical signing by using the public key,
generate the template from the biometric data by using the first random number when verification of the electrical signing succeeds, and
transmit the template to the second server.

3. The authentication system according to claim 1, wherein
the first processor is configured to:
generate a second random number based on second identification information of a second service provided by the second server;
acquire a third random number from a third server that is different from the second server; and
change the second random number when the third random number is the same as the second random number.

4. The authentication system according to claim 2, wherein
the terminal device is configured to:
receive transmission information indicating that the first server transmits the signature random number to the second server; and
generate the template by using the first random number when the verification of the electrical signing succeeds.

5. The authentication system according to claim 2, wherein
the terminal device is configured to:
generate a conversion parameter by using the first random number; and
generate the template by using the conversion parameter.

6. The authentication system according to claim 1, wherein
the first processor is configured to:
electrically sign the first random number by using the secret key; and
transmit the signature random number to the second server.

7. The authentication system according to claim 1, wherein
the second processor is configured to manage the signature random number with respect to each of the services.

8. The authentication system according to claim 2, wherein
the second processor is configured to:
generate a challenge;
transmit the first random number and the challenge to the terminal device; and
authenticate the template by using the first random number and the challenge.

9. A method of authentication process by using a template generated from biometric data, the method comprising:
generating, by a first server, based on first identification information of a first service provided by a second server, a first random number used for generating the template from the biometric data;
generating, by the first server, a signature random number by electrical signing of the first random number by using a secret key;
transmitting, from the first server to the second server, the signature random number;
verifying, by the second server, the electrical signing by using a public key that corresponds to the secret key; and
storing, by the second server, into a memory, the signature random number when verification of the electrical signing succeeds.

10. The method according to claim 9, further comprising:
acquiring, by a terminal device, the biometric data;
receiving, by the second server, the first identification information from the terminal device;
transmitting, from the second server to the terminal device, the signature random number corresponding to the first identification information;
verifying, by the terminal device, the electrical signing by using the public key;
generating, by the terminal device, the template from the biometric data by using the first random number when verification of the electrical signing succeeds; and
transmitting, from the terminal device to the second server, the template.

11. The method according to claim 9, further comprising:
generating, by the first server, a second random number based on second identification information of a second service provided by the second server;
acquiring, by the first server, a third random number from a third server that is different from the second server; and
changing, by the first server, the second random number when the third random number is the same as the second random number.

12. The method according to claim 11, further comprising:
receiving, by the terminal device, transmission information indicating that the first server transmits the signature random number to the second server; and
generating, by the terminal device, the template by using the first random number when the verification of the electrical signing succeeds.

13. The method according to claim 10, further comprising:
generating, by the terminal device, a conversion parameter by using the first random number; and
generating, by the terminal device, the template by using the conversion parameter.

14. The method according to claim 9, further comprising:
electrically signing, by the first server, the first random number by using the secret key; and
transmitting, from the first server to the second server, the signature random number.

15. A non-transitory computer-readable storage medium storing a program that causes an information processing apparatus to execute a process of authentication by using a template generated from biometric data, the process comprising:
generating, by a first server, based on first identification information of a first service provided by a second server, a first random number used for generating the template from the biometric data;
generating, by the first server, a signature random number by electrical signing of the first random number by using a secret key;
transmitting, from the first server to the second server, the signature random number;
verifying, by the second server, the electrical signing by using a public key that corresponds to the secret key; and
storing, by the second server, into a memory, the signature random number when verification of the electrical signing succeeds.

16. The non-transitory computer-readable storage medium according to claim 15, the process further comprising:
acquiring, by a terminal device, the biometric data;
receiving, by the second server, the first identification information from the terminal device;
transmitting, from the second server to the terminal device, the signature random number corresponding to the first identification information;
verifying, by the terminal device, the electrical signing by using the public key;
generating, by the terminal device, the template from the biometric data by using the first random number when verification of the electrical signing succeeds; and
transmitting, from the terminal device to the second server, the template.

17. The non-transitory computer-readable storage medium according to claim 15, the process further comprising:
generating, by the first server, a second random number based on second identification information of a second service provided by the second server;
acquiring, by the first server, a third random number from a third server that is different from the second server; and
changing, by the first server, the second random number when the third random number is the same as the second random number.

18. The non-transitory computer-readable storage medium according to claim 17, the process further comprising:
receiving, by the terminal device, transmission information indicating that the first server transmits the signature random number to the second server; and
generating, by the terminal device, the template by using the first random number when the verification of the electrical signing succeeds.

19. The non-transitory computer-readable storage medium according to claim 16, the process further comprising:
generating, by the terminal device, a conversion parameter by using the first random number; and
generating, by the terminal device, the template by using the conversion parameter.

20. The non-transitory computer-readable storage medium according to claim 15, the process further comprising:
electrically signing, by the first server, the first random number by using the secret key; and
transmitting, from the first server to the second server, the signature random number.
